(19) United States
(12) Patent Application Publication
(10) Pub. No.: US 2017/0358125 A1
(43) Pub. Date: Dec. 14, 2017

(54) RECONFIGURING A DOCUMENT FOR SPATIAL CONTEXT

(71) Applicant: Microsoft Technology Licensing, LLC., Redmond, WA (US)

(72) Inventors: Blair Justice Neumann, Seattle, WA (US); Szu-Wei Silvia Fu, Kirkland, WA (US)

(73) Assignee: Microsoft Technology Licensing, LLC., Redmond, WA (US)

(21) Appl. No.: 15/181,340

(22) Filed: Jun. 13, 2016

(51) Int. Cl. G06T 15/20; G06T 19/00; G06K 9/00; G06F 3/0481

(52) U.S. Cl. CPC G06T 15/20; G06F 3/04815; G06T 19/003; G06K 9/00442

(57) ABSTRACT

Document reconfiguration for improved user efficiency is provided. Document content items in a document are reconfigured such that the content items are anchored to various objects displayed in a contiguous 3D space. The 3D space is navigated via realistic virtual camera movements between the document content items anchored to the various objects in a sequential order, wherein each object on which a document content item is anchored is a key frame and a stopping point in an animated virtual tour of the 3D space. Accordingly, each document content item is given spatial context associated with its location in the 3D space, enabling a user to associate document content with locations in the 3D space. Thus, the user's ability to recall the presented content is improved by enabling the user to employ spatial memory.

### BACKGROUND

Spatial memory is the part of memory responsible for recording information about one's environment and its spatial orientation. People are typically good at remembering spatial information. Accordingly, by giving information a spatial context, such as placing pieces of information in an imagined sequence of locations, stronger memories can be formed. This technique is sometimes referred to as the “method of loci” or the “memory palace technique,” and dates back to Roman and Greek orators who used such methods to memorize long speeches. For example, a memory palace is a place that an individual can imagine, such as a building, a city, a commute, etc., comprising a plurality of distinct locations. An individual can sequentially go around to the different locations (in the individual's mind), and associate pieces of information that he/she wants to remember with the different locations. Later, when the individual wants to recall the pieces of information, the individual can travel through the locations in his/her mind and recall the associated information.

Information that a person may want to recall may include information presented to the person, such as in an electronic slide presentation. An electronic slide presentation is a widely used tool across a variety of enterprises to communicate information to various audiences. For example, some popular uses of electronic slide presentations are as a teaching aid in a classroom setting, in corporate training sessions, business and marketing meetings, sales gatherings, etc. An electronic slide presentation typically includes a number of individual pages or slides, wherein a “slide” is analogous to a photographic slide shown via a slide projector. An author of an electronic slide presentation may include information in each slide in the form of text, graphics, sound, movies, and other objects. Generally, slides are displayed on discontiguous flat backgrounds, which provide no concept of space, and thus the applicability of spatial memory in association with content included in the electronic slide presentation is limited.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to an automated system, method, and computer storage media for generating and applying spatial context to a document by reconfiguring document content into a contiguous three-dimensional (3D) space. For example, document content items are reconfigured such that the content items are anchored to various objects displayed in the contiguous 3D space. A user's efficiency in utilizing a productivity application to view the document is increased by anchoring the document content in the 3D space and enabling animated sequential transitions between the document content items anchored to the various objects via realistic virtual camera movements.

Examples are implemented as a computer process, a computing system, or as an article of manufacture such as a device, computer program product, or computer readable media. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a simplified block diagram showing components of an example system for generating and applying spatial context to a document;

FIG. 2 is a simplified block diagram showing a 3D space;

FIG. 3A is an illustration of an example application user interface display showing a slide presentation document;

FIG. 3B is an illustration of an example application user interface display showing a display of one or more 3D spaces from which a user may select to apply to a document;

FIG. 3C is an illustration of an example application user interface display showing a first key frame in a virtual tour of the document in a 3D space;

FIG. 3D is an illustration of an example application user interface display showing a second slide of the document in a second key frame in the virtual tour of the 3D space;

FIG. 3E is an illustration of an example application user interface display showing a transition from the second key frame to a third key frame in the virtual tour of the 3D space;

FIG. 3F is an illustration of an example application user interface display showing a third key frame in a virtual tour of the 3D space;

FIGS. 3G and 3H are illustrations of an example application user interface display showing a transition from the third key frame to a fourth key frame in the virtual tour of the 3D space;

FIG. 3I is an illustration of an example application user interface display showing a fourth slide of the document in the fourth key frame in the virtual tour of the 3D space;

FIG. 4 is a flow chart showing general stages involved in an example method for reconfiguring a document into a 3D space;

FIG. 5 is a block diagram illustrating example physical components of a computing device;

FIGS. 6A and 6B are simplified block diagrams of a mobile computing device; and

FIG. 7 is a simplified block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer storage media for generating and applying spatial context to a document. For example, document content items are reconfigured such that the content items are anchored to various objects displayed in the contiguous 3D space. The 3D space is navigated sequentially to present the document content to the user, wherein each object on which a document content item is anchored is a key frame and a stopping point in a virtual tour of the 3D space. Accordingly, each document content item is given spatial context associated with its location in the 3D space. The user is enabled to associate document content with locations in the 3D space, thus improving the user's ability to recall the presented content by employing spatial memory.

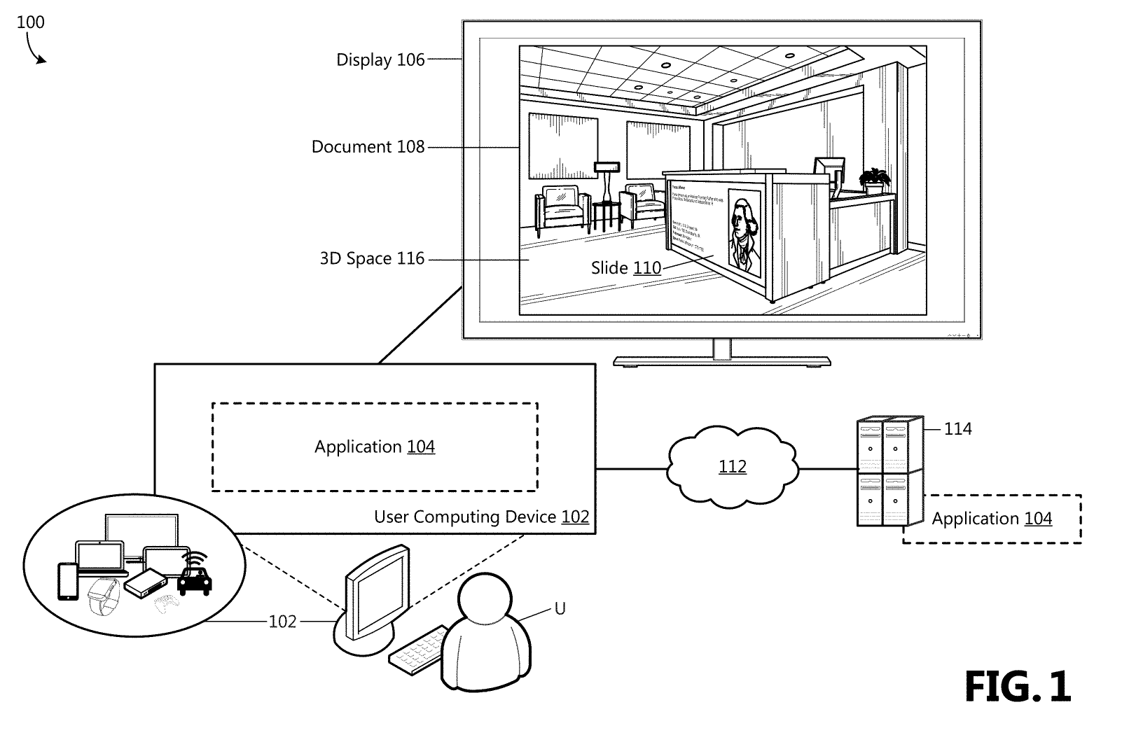

With reference now to FIG. 1, a simplified block diagram illustrating aspects of an example system 100 for generating and applying spatial context to a document is shown. The example system 100 includes a computing device 102, wherein the computing device 102 may be one of various types of computing devices (e.g., a tablet computing device, a desktop computer, a mobile communication device, a laptop computer, a laptop/tablet hybrid computing device, a large screen multi-touch display, a gaming device, a smart television, a wearable device, a connected automobile, a smart home device, or other type of computing device) for executing applications 104 for performing a variety of tasks.

A user U may utilize an application 104 on a computing device 102 for a variety of tasks, which may include, for example, to write, calculate, draw, organize, prepare and view presentations, send and receive electronic mail, take and organize notes, make music, and the like. Applications 104 may include thick client applications, which may be stored locally on the computing device 102 (as illustrated in FIG. 1), or may include thin client applications (i.e., web applications) that may reside on a remote server 114 and accessible over a network 112 or combination of networks (e.g., the Internet, wide area networks, local area networks). A thin client application may be hosted in a browser-controlled environment or coded in a browser-supported language and reliant on a common web browser to render the application executable on a computing device 102.

The computing device 102 is configured to receive content for input into a document 108 (e.g., a word processing document, a slide presentation document, a spreadsheet document, a notes document, and the like). For example, content may include various content items (e.g., text, charts, tables, images, videos). In examples, the application 104 receives input from a user, such as input relating to the document content, via various input methods, such as those relying on mice, keyboards, and remote controls, as well as Natural User Interface (NUI) methods, which enable a user to interact with a device in a “natural” manner, such as via speech recognition, touch and stylus recognition, gesture recognition both on screen and adjacent to the screen, air gestures, head and eye tracking, voice and speech, vision, touch, hover, gestures, and machine intelligence. The user input results in content being added to the document 108.

In some aspects, a document 108 is comprised of a plurality of pages. In a slide presentation document, a single page is a slide 110. According to examples, a slide presentation document is comprised of a plurality of slides 110 arranged in a sequential order. When content is added to a slide presentation document 108, the content is added to a particular slide 110. This disclosure includes many examples that relate to slide presentation documents. It should be understood, however, that many of these examples are applicable to other types of documents 108 as well.

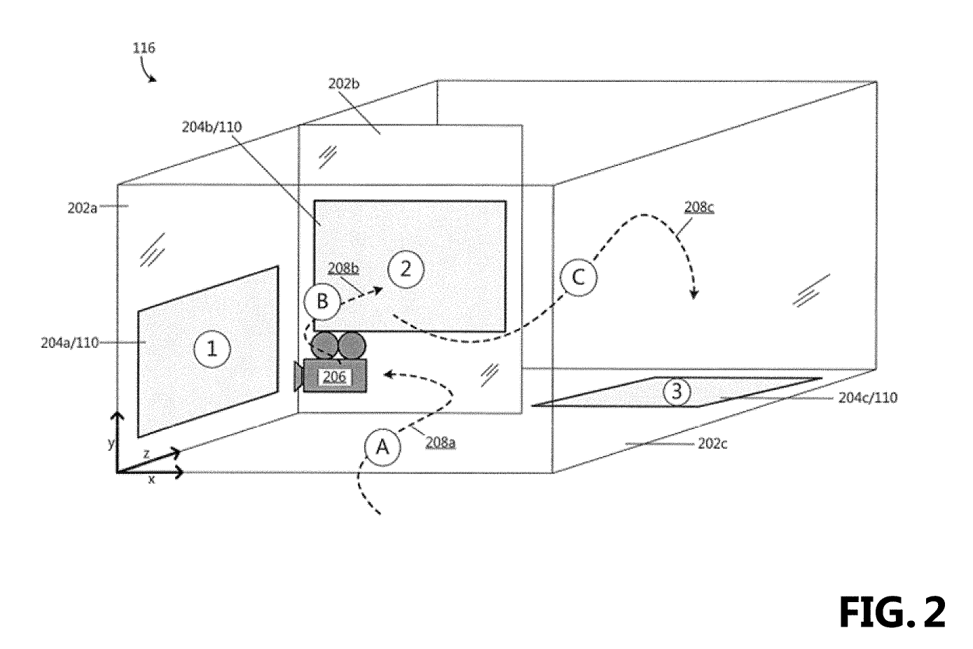

According to aspects, the application 104 operates to reconfigure document content into a contiguous three-dimensional (3D) space 116. For example and with reference now to FIG. 2, the 3D space 116 is a navigable 3D environment. In some examples, the 3D space 116 is a collection of overlapping two-dimensional (2D) images (e.g., photographs) that are reconstructed into a 3D model of the space. In other examples, the 3D space 116 is a recorded video capture of an environment. In other examples, the 3D space 116 is a computer-generated imagery (CGI) modeled environment. According to an aspect, the 3D space 116 comprises a plurality of salient features or objects 202a-c (generally, 202) that are configured to be key frames in a virtual tour of the environment. The plurality of salient features or objects 202 may include various locations in the 3D space 116 such as walls, furniture, floors, buildings, streets, sidewalks, signs, trees, and other locations that are distinct from other locations and on which document content can be displayed.

According to an aspect, portions of document content 204a-c (generally, 204) are reconfigured such that document content is anchored to various objects 202 along a virtual path through the 3D space 116, wherein spatial relations of the objects 202 to each other enable a viewing user to experience each portion of document content 204 in context of its location in the 3D space 116. In some examples, the portions of document content 204 that are anchored to objects 202 in the 3D space 116 are pages or slides 110 of the document 108. In other examples, the portions of document content 204 are individual content items, such as text, charts, tables, images, videos, etc., anchored to various objects 202 in the 3D space 116.

As mentioned above, the objects 202 on which document content 204 are anchored are key frames in a virtual tour of the 3D space 116. For example, when a user views the document 108, portions of the document (e.g., slides 110, pages, content items) are sequentially displayed on objects 202 throughout the 3D space 116. According to an aspect, navigation of the document 108 includes movement of a virtual camera 206 through the 3D space 116, providing an animated view of the 3D space. Transitions 208a-c (generally, 208) between the portions of the document content 204 occur when a user moves from one document portion to a next document portion during an on-screen display or presentation of the document 108. According to an aspect, a transition 208 includes a realistic movement of the virtual camera 206 through the 3D space 116 to an object 202 on which the next portion of the document content 204 is anchored. For example, if the document 108 is a slide presentation document, transitions 208 between the slides 110/204 are simulated as a virtual walk from a first slide to a next slide through the 3D space 116. Each portion of document content 204 is given spatial context associated with its location in the 3D space 116, thus enabling the user to associate the portions of document content 208 with particular locations in the 3D space. Accordingly, the user's efficiency in utilizing the application 104 is increased, and the user's ability to recall the presented content is improved by employing spatial memory.

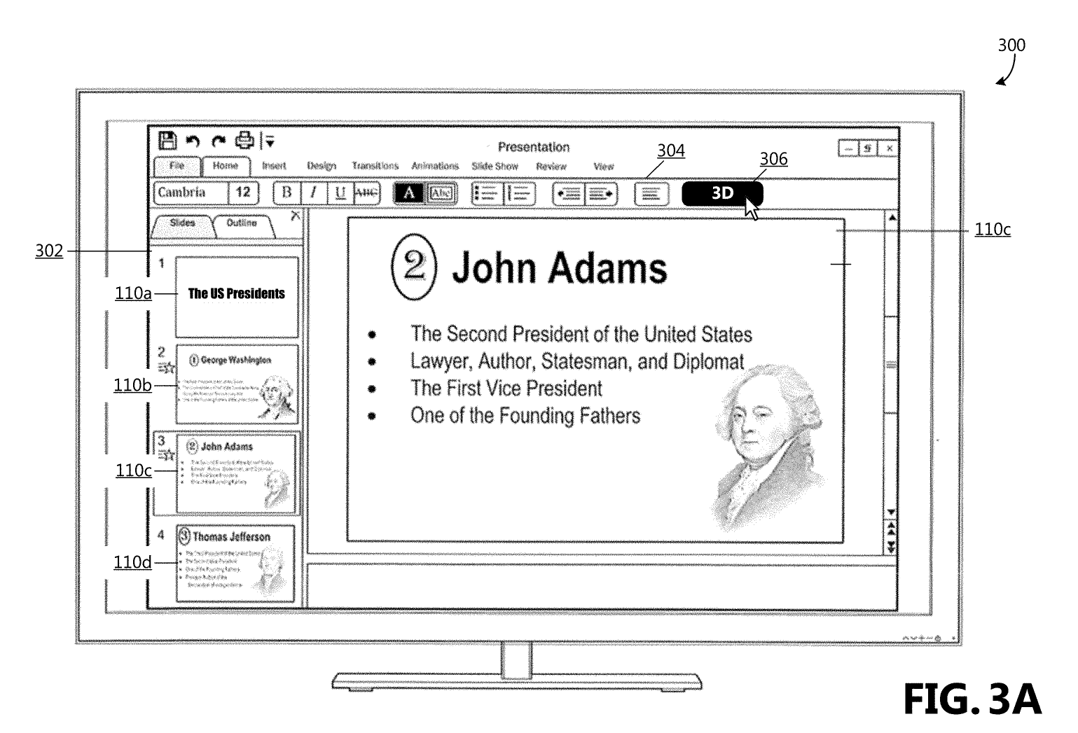

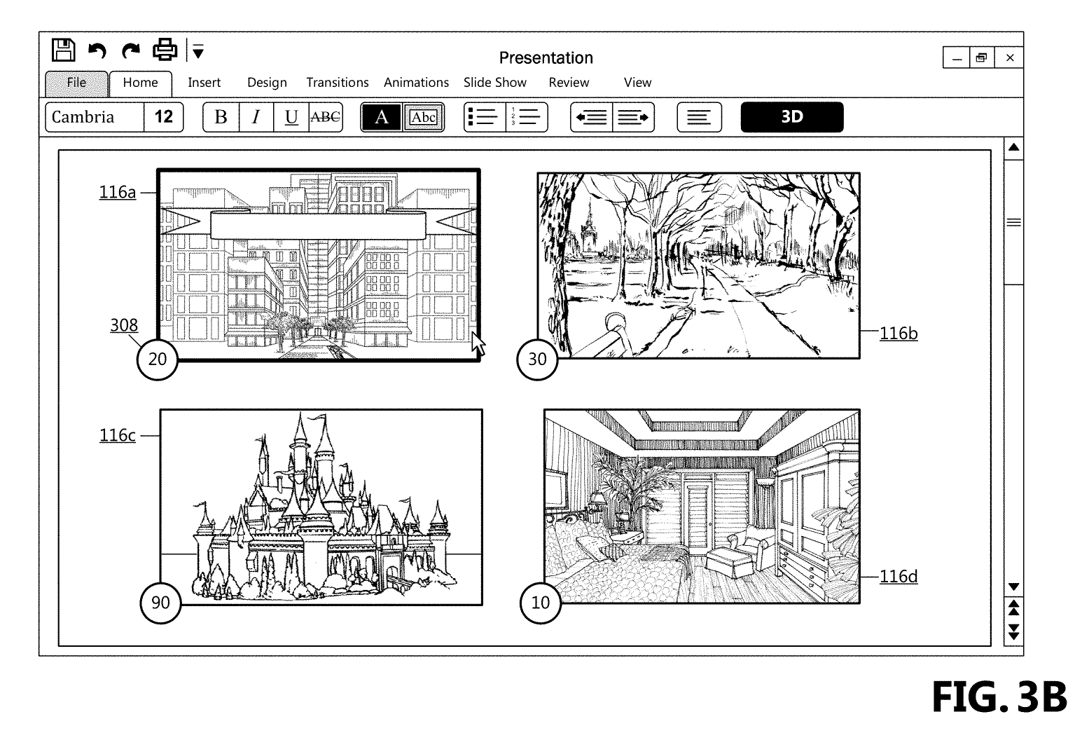

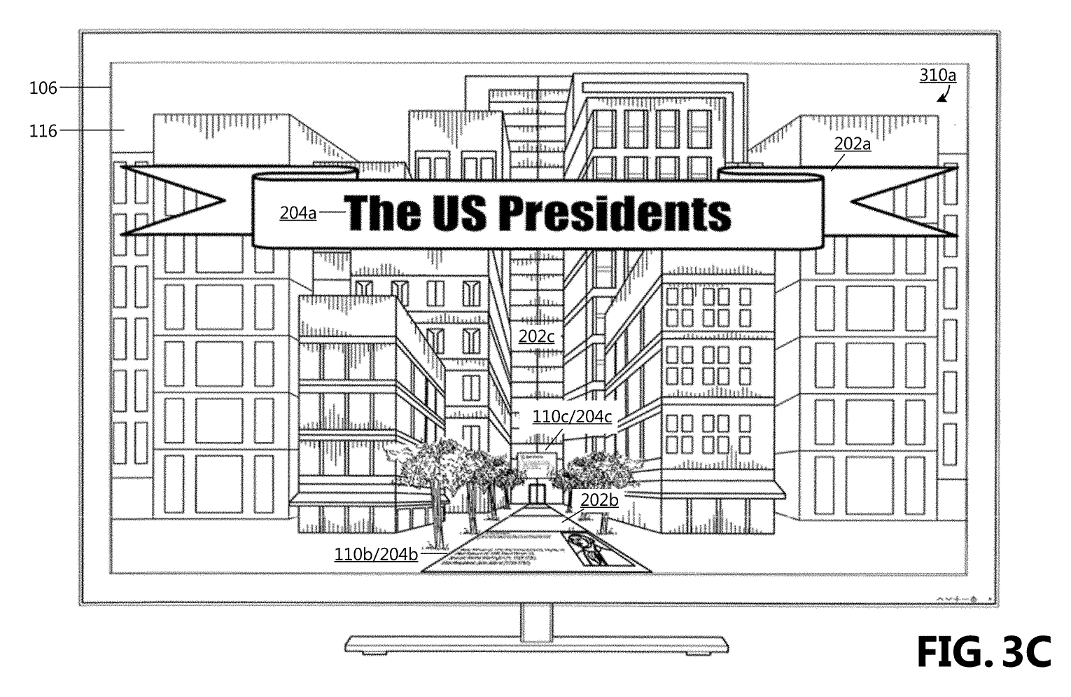

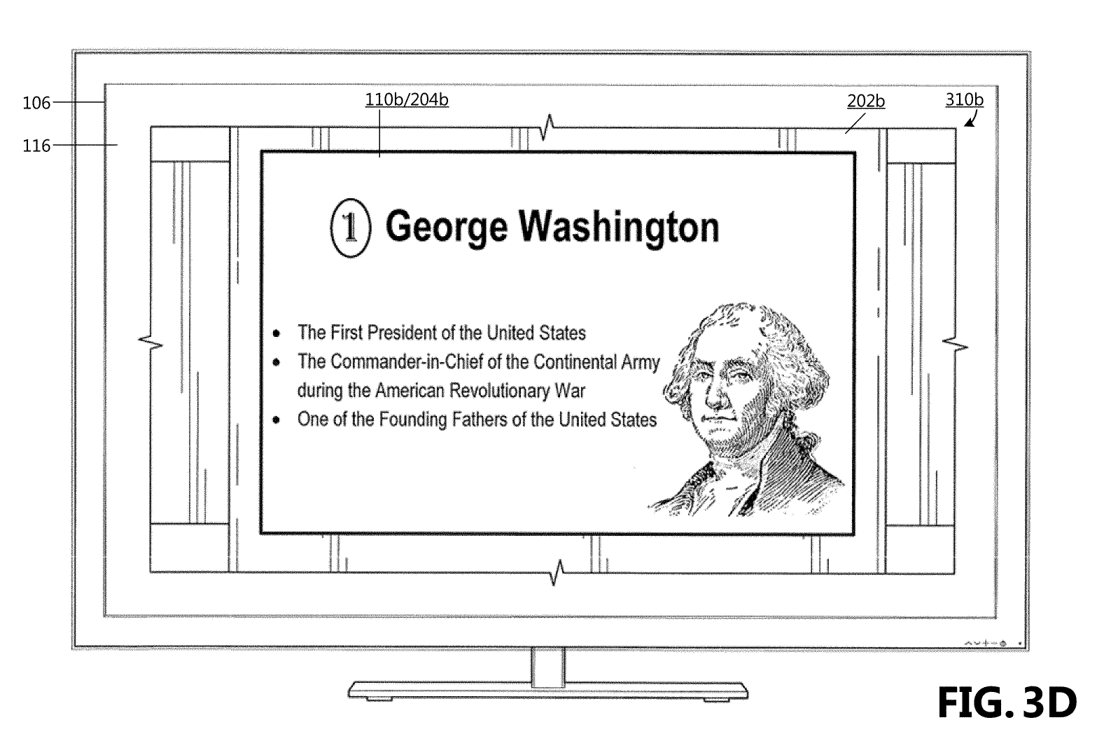

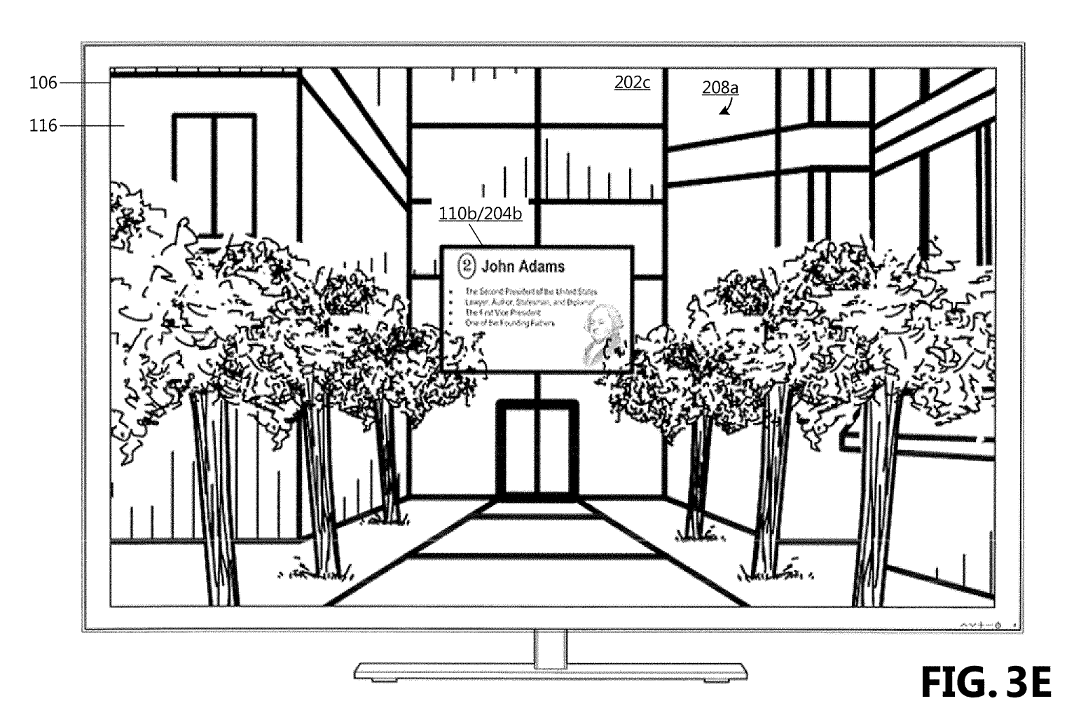

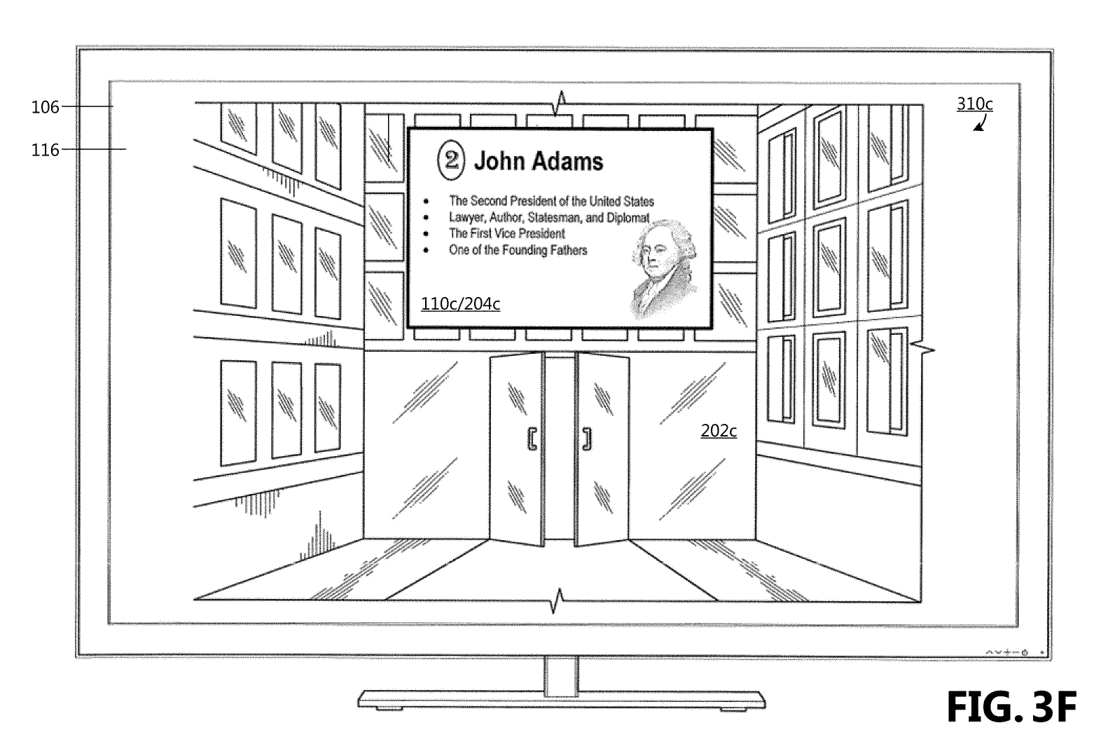

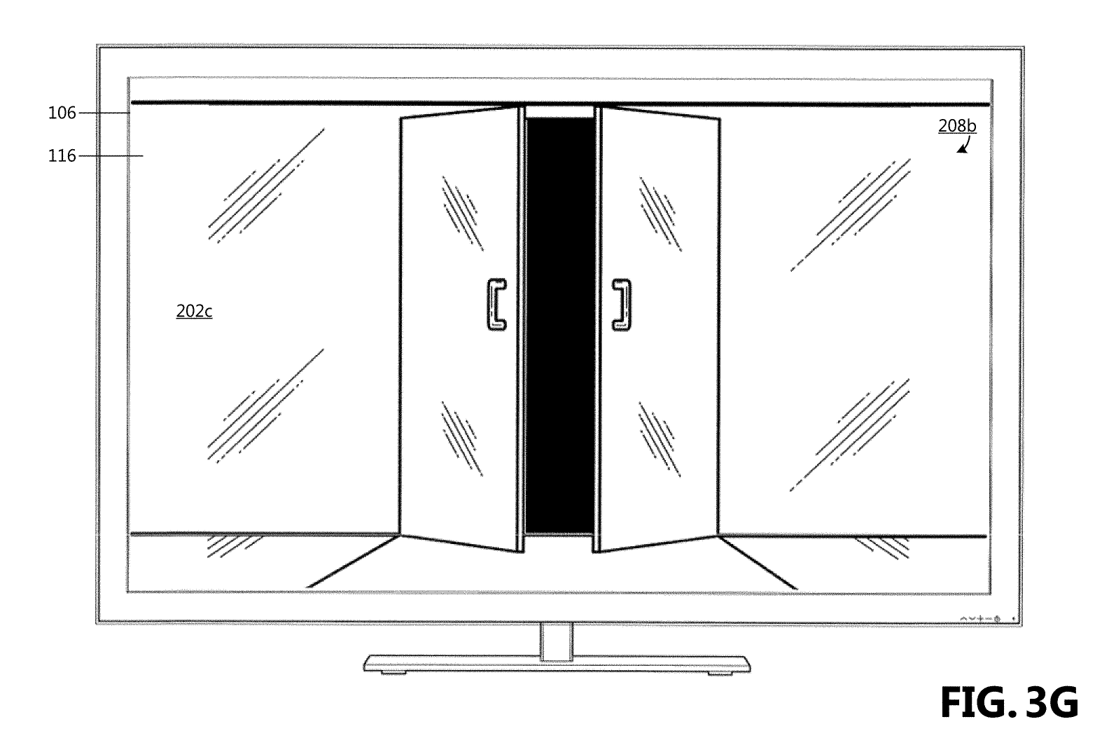

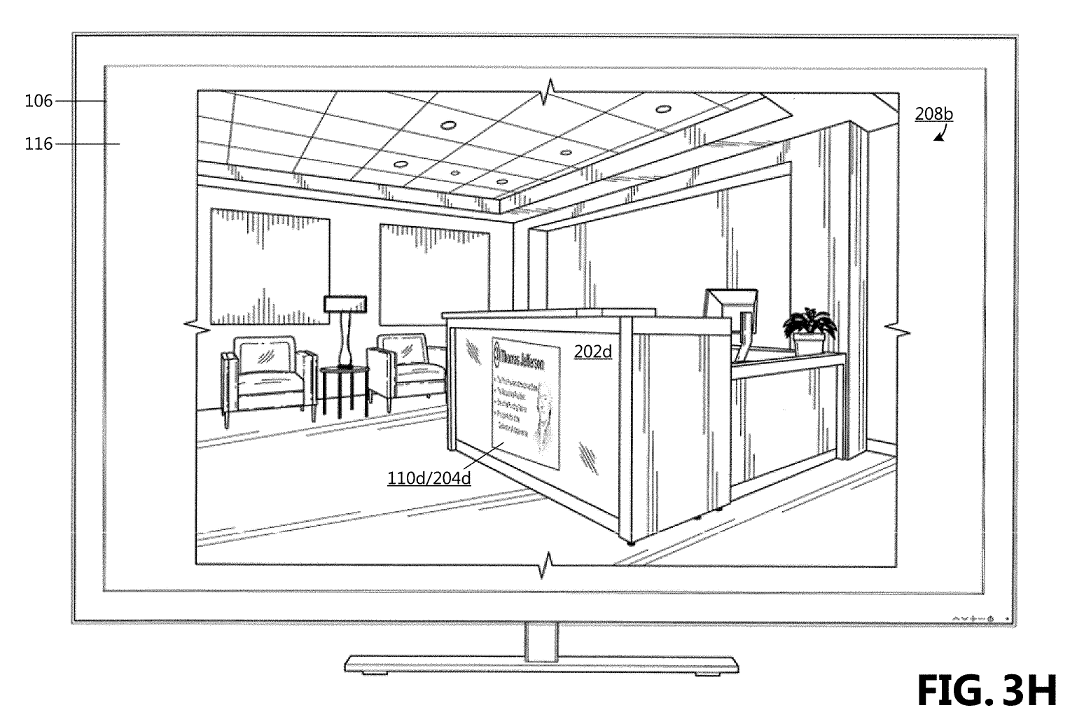

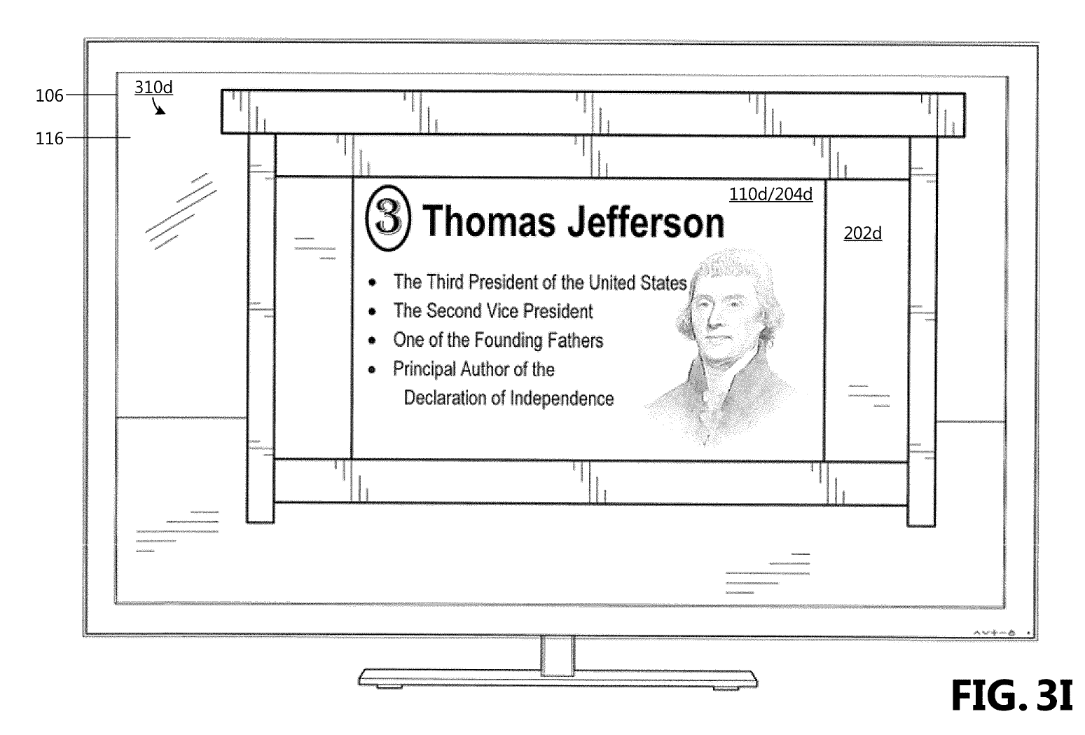

With reference now to FIGS. 3A-3I, example application user interfaces are illustrated that may be displayed on any suitable computing device display 106. In the illustrated examples, the application user interfaces comprise a display of a slide presentation document 108. In FIG. 3A, the slide presentation document 108 is shown in a normal or editing mode. In some examples, the application user interface 300 includes a slide pane 302 comprising thumbnails of the slides 110a-d (collectively, 110) in the document 108. As described above, a user U may input various content items, such as text, charts, tables, images, videos, etc., into a slide 110. In some examples, the user U may apply animations to the slide 110, such as entrance or exit animation effects, sound effects, motion paths of content items, etc. In other examples, the user U may record a narration to apply to the document 108.

As illustrated, the user interface 300 may comprise a toolbar 304 that includes various functionalities, tools, and settings related to authoring the document 108, such as: cut, copy, and paste tools; font settings; animation settings, layout settings; etc. In other examples, the toolbar 304 includes fewer, additional, or different tools, functionalities, and settings. According to an aspect, a functionality command 306 is provided for enabling a user to select to reconfigure the document 108 into a 3D space 116. For example, the functionality command 306 may be provided in the toolbar 304 as illustrated. In other examples, reconfiguration of the document 108 into a 3D space 116 may be invoked via other methods, such as via voice command, keyboard input, or other command.

According to an example and as illustrated in FIG. 3B, upon receiving an indication of a selection to reconfigure the document 108 into a 3D space 116, the application 104 is operative to provide a display of one or more 3D spaces 116a-d (collectively, 116) from which the user U may select to apply to the document 108. In some examples, each 3D space 116 may have a maximum number of objects 202 that are available for anchoring document content 204. As illustrated in FIG. 3B, the number 308 of available objects 202 in the 3D space 116 that can be used to anchor document content 204 to is displayed. For example, if a slide presentation document 108 has 50 slides 110, the user U may select 3D space 116c in order to have enough objects 202 for anchoring each of the slides. In some examples, the application 104 is operative to automatically select a 3D space 116 for reconfiguration of the document 108. The selection may be based on various factors, such as a number of slides 110 or pages in the document 108, the type of content 204 included in the document 108, previously used 3D spaces 116, or other factors. According to an aspect, when the user U selects a 3D space 116 (or when the user U selects a 3D functionality command 306), the application 104 is operative to reconfigure the document 108 into the selected 3D space 116. For example, if the document 108 is a slide presentation document, for each slide 110 in the document, the application 104 extracts the slide, and anchors the slide to a first available object 202 in the 3D space 116.

FIGS. 3C-3I show examples of a presentation of the document 108 in the 3D space 116. With reference now to FIG. 3C, a first key frame 310a in the virtual tour of the 3D space 116 includes content 204 from the first slide 110a, the second slide 110b, and the third slide 110c anchored to objects in the 3D space 116. For example, textual content 204a from the first slide 110a is anchored to a banner object 202a, the second slide 110b is anchored to a sidewalk object 202b, and the third slide 110c is anchored to a building object 202c above a doorway.

With reference now to FIG. 3D, an example of a second key frame 310b is illustrated. According to an aspect, the presentation of the document 108 includes transitions 208 between key frames 310. For example, the transition 208 from the first key frame 310a to the second key frame 310b is a virtual navigation via the virtual camera 206 along a path from a view of the first slide 110a anchored to a first object 202a to a view of the second slide 110b anchored to a second object 202b. In the illustrated example, the second slide 110b is shown anchored to a sidewalk object 202b, and the second key frame 310b is a top view of the second slide 110b.

With reference now to FIG. 3E, an example of a transition 208a from the second key frame 310b to a third key frame is illustrated. For example, the movement of the virtual camera 206 through the 3D space 116 may include panning upward from the second slide 110b anchored to the sidewalk object 202b, and moving along the z-axis towards the building object 202c where the third slide 110c is anchored. Transitions 208 may include various types of movements (e.g., zooming, panning, sweeping). In some examples, the transition 208 is a smooth movement. In other examples, the transition 208 simulates a human's walking motion. Other examples may simulate movement of a vehicle, such as an automobile, airplane, helicopter, boat, drone, etc., movement of an animal, etc. According to an aspect, a transition 208 may include movement of document content 204 (e.g., a slide 110) into the 3D space 116. For example, the content 204/slide 110 may be anchored to a mobile object 202 that moves into the environment.

Transitions 208 between key frames 310 may occur automatically, such as after a preset duration of display of the previous key frame, or may occur in response to user interaction, such as a mouse or other pointer click, a gesture, voice command, etc. In some examples, transitions 208 are controllable via a user U. For example, the user U may be enabled to control the speed of the transition 208, camera panning, zooming, the direction of movement, and the like. According to one aspect, if a user U wishes to transition from one slide 110 to a previous slide, the transition 208 may include a virtual camera 206 movement simulating turning from the currently-viewed slide, and moving toward the previous slide following the path back to the previous slide.

FIG. 3F is an illustration of an example of the third key frame 310c. For example, the third key frame 310c includes a zoomed-in display of the third slide 110c anchored to the building object 202c. FIGS. 3G and 3H illustrate an example transition 208b from the third key frame 310c to a fourth key frame 310d. FIG. 31 is an illustration of the fourth key frame in the virtual tour of the 3D space 116. For example, in the fourth key frame 310d, the fourth slide 110d of the document 108 is shown anchored to a receptionist desk object 202d. Although the illustrated examples show slides 110a-d anchored to objects 202a-d in the 3D space 116, in some examples, select document content items 204 (e.g., text, charts, graphs, images, videos) may be extracted from a page or slide 110 and anchored to objects. According to an aspect, the document 108 may include a number of additional slides 110. Presentation of the document 108 continues with sequential transitions through the additional slides 110 shown anchored to additional objects 202 along a virtual pathway through the 3D space 116. As should the appreciated, the user interface displays 300 illustrated in FIGS. 3A-3I are for purposes of illustration. Aspects may be implemented in many different forms and should not be construed as limited to the illustrated examples.

Having described an operating environment and various user interface display examples with respect to FIGS. 1-31, FIG. 4 is a flow chart showing general stages involved in an example method 400 for restructuring a document 108 into a 3D space 116. The method 400 starts at OPERATION 402, where a document 108 is created or opened in an application 104. For example, the document 108 may be a word processing document, a spreadsheet document, a slide presentation document, or other type of document.

The method 400 proceeds to OPERATION 404, where a selection to reconfigure the document 108 into a 3D space 116 is received. For example, a user U may select a functionality command 306, such as the example functionality command illustrated in FIG. 3A, or input another command for instructing the application 104 to reconfigure the document 108 into a 3D space 116. In some examples, the user U may be presented with various 3D spaces 116 from which to select to apply to the document 108, such as illustrated in the example interface of FIG. 3B. In other examples, a 3D space 116 is automatically selected.

The method 400 continues to OPERATION 406, where the application 104 reconfigures the document 108 into the 3D space 116. For example, portions of the document content 204 (e.g., slides 110, pages, content items) are sequentially anchored to various objects 202 along a virtual path in the 3D space 116. For example, document content 204 is linked to a surface of an object 202 in the 3D space 116. In some examples, the objects 202 to which to link to document content 204 are automatically selected. For example, certain objects 202 within the 3D space 116 may be more preferential for anchoring content to due to various factors, such as size, location, proximity to other objects, a level of salience, etc. In an example, when a number of document content items 204 in a document 108 are less than the number of objects 202 in the 3D space 116 that are available to link content to, the application 104 may automatically select a preferred group of objects 202. According to an aspect, the reconfigured document is saved as a presentation-version of the document 108.

At OPERATION 408, an indication of a selection to present the document 108 is received. For example, a functionality command associated with displaying the document in a presentation mode may be selected by a user U. In response, the method 400 proceeds to OPERATION 410, where the application user interface 300 is updated to display the presentation-version of the document 108. For example, the portions of the document 108 are sequentially displayed on a screen 106 in a virtual walk-through of the 3D space 116, wherein the portions of document content 204 are anchored to objects 202 in the 3D space. As described above, a virtual camera 206 transitions between key frames 310, where a focus is made on a next document content portion anchored to an object 202. Accordingly, each portion of document content 204 (e.g., page, slide, content item) is given spatial context associated with its location in the 3D space 116, enabling the viewing user to associate document content with locations in the 3D space and thus improve the user's ability to recall the presented content by employing spatial memory. The method 400 ends at OPERATION 498.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

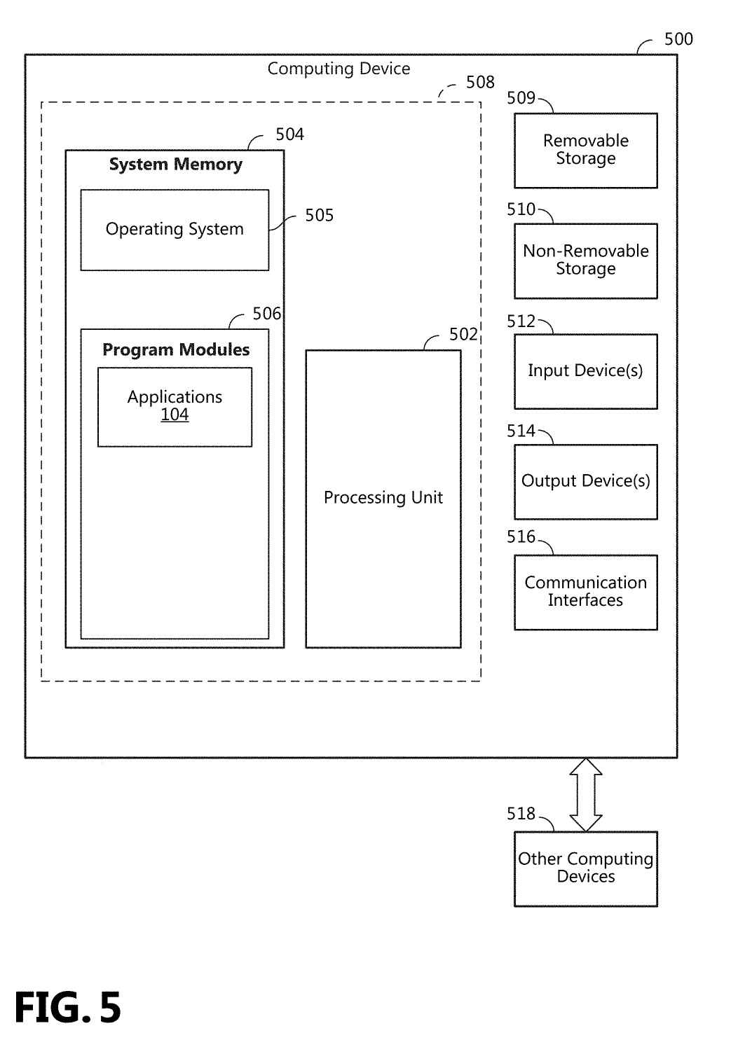

FIGS. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are utilized for practicing aspects, described herein.

FIG. 5 is a block diagram illustrating physical components (i.e., hardware) of a computing device 500 with which examples of the present disclosure may be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550. According to an aspect, the system memory 504 includes productivity application 104. The operating system 505, for example, is suitable for controlling the operation of the computing device 500. Furthermore, aspects are practiced in conjunction with a graphics library, other operating systems, or any other application program, and is not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

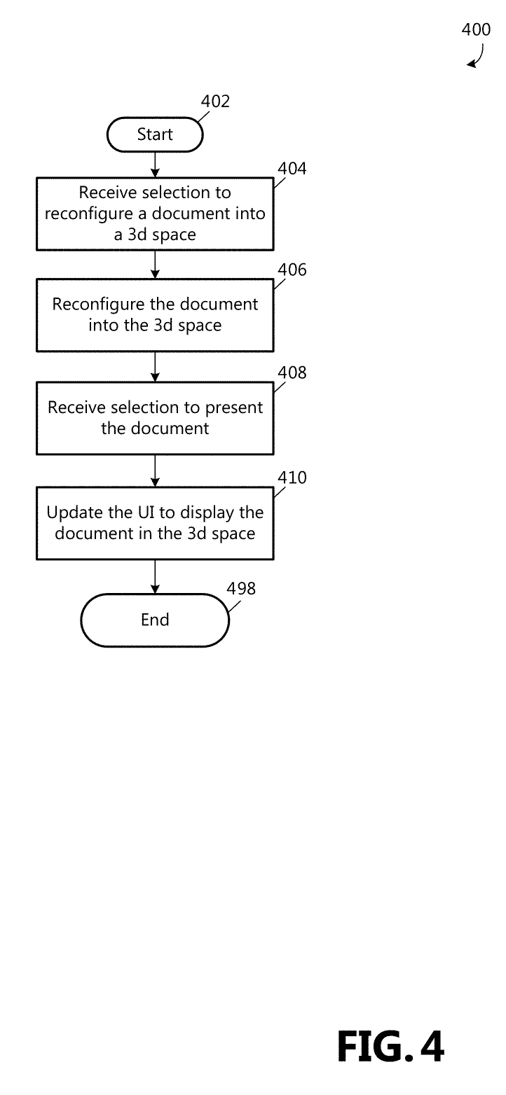

As stated above, according to an aspect, a number of program modules and data files are stored in the system memory 504. While executing on the processing unit 502, the program modules 506 (e.g., productivity application 104) perform processes including, but not limited to, one or more of the stages of the method 400 illustrated in FIG. 4. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 5 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

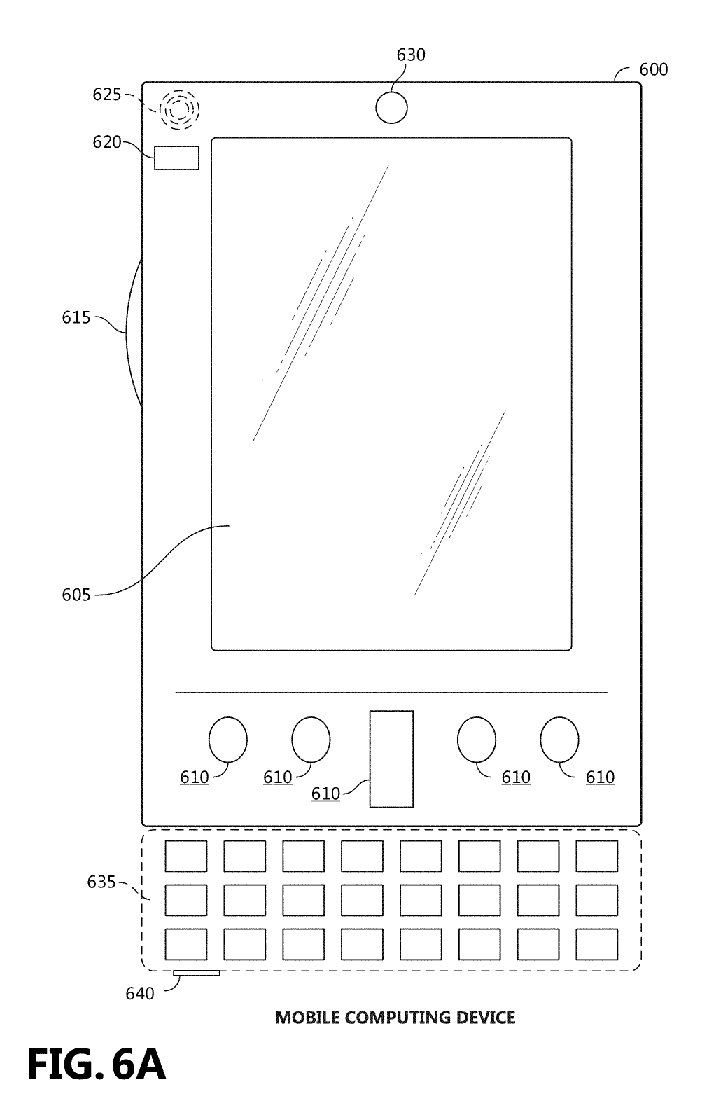

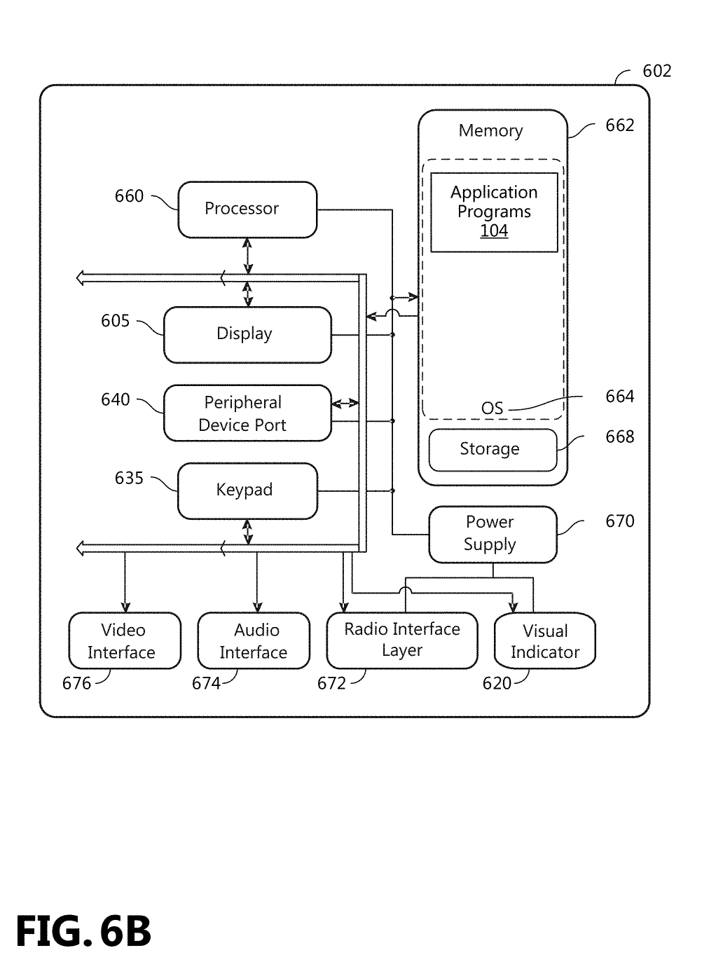

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or less input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, productivity application 104 is loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668.

According to an aspect, data/information generated or captured by the mobile computing device 600 and stored via the system 602 is stored locally on the mobile computing device 600, as described above. According to another aspect, the data is stored on any number of storage media that is accessible by the device via the radio 672 or via a wired connection between the mobile computing device 600 and a separate computing device associated with the mobile computing device 600, for example, a server computer in a distributed computing network, such as the Internet. As should be appreciated such data/information is accessible via the mobile computing device 600 via the radio 672 or via a distributed computing network. Similarly, according to an aspect, such data/information is readily transferred between computing devices for storage and use according to well-known data/information transfer and storage means, including electronic mail and collaborative data/information sharing systems.

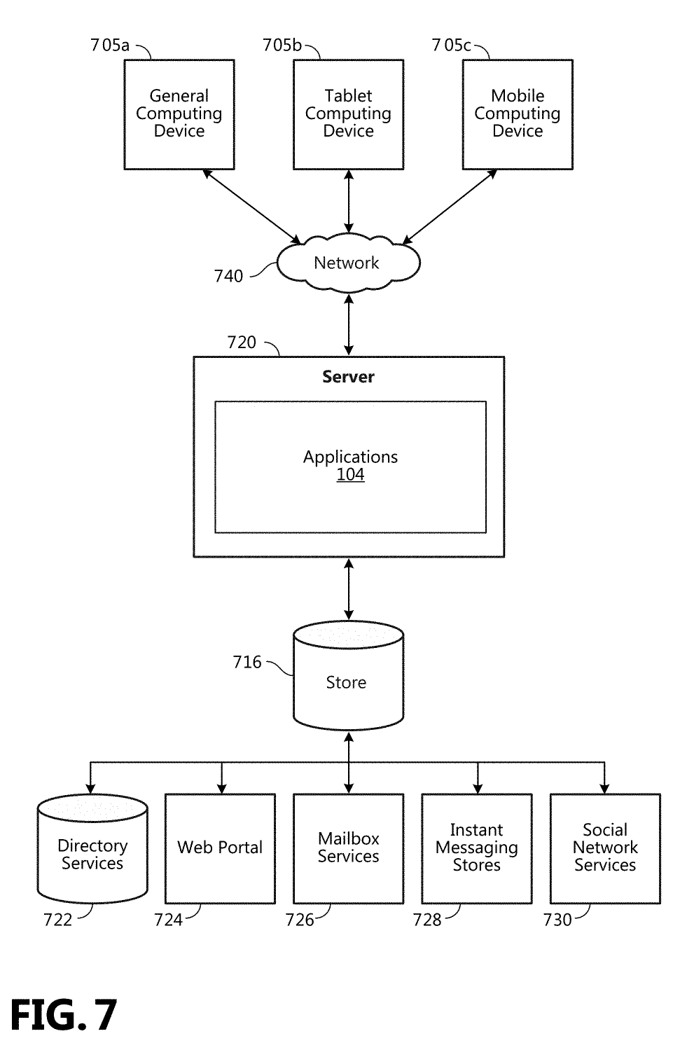

FIG. 7 illustrates one example of the architecture of a system for restructuring a document 108 into a 3D space 116 as described above. Content developed, interacted with, or edited in association with the productivity application 104 is enabled to be stored in different communication channels or other storage types. For example, various documents may be stored using a directory service 722, a web portal 724, a mailbox service 726, an instant messaging store 728, or a social networking site 730. The productivity application 104 is operative to use any of these types of systems or the like for restructuring a document 108 into a 3D space 116, as described herein. According to an aspect, a server 720 provides the productivity application 104 to clients 705a,b,c. As one example, the server 720 is a web server providing the productivity application 104 over the web. The server 720 provides the productivity application 104 over the web to clients 705 through a network 740. By way of example, the client computing device is implemented and embodied in a personal computer 705a, a tablet computing device 705b or a mobile computing device 705c (e.g., a smart phone), or other computing device. Any of these examples of the client computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method for improving user efficiency in utilizing a productivity application for viewing a document with spatial context, comprising:
receiving an indication of a selection to reconfigure the document into a three-dimensional (3D) space;
anchoring document content to a plurality of objects within the 3D space;
receiving an indication of a selection to present the document; and
displaying an animated view of the 3D space including a sequential display of the document content anchored to the plurality of objects along a virtual path through the 3D space.

2. The method of claim 1, wherein anchoring document content to a plurality of objects within the 3D space comprises linking a page of the document to a surface of an object.

3. The method of claim 2, wherein anchoring document content to a plurality of objects within the 3D space comprises linking a slide of a slide presentation document to a surface of an object.

4. The method of claim 2, wherein anchoring document content to a plurality of objects within the 3D space comprises linking a content item in the document to a surface of an object, wherein a content item comprises one of:
text;
a chart;
a table;
an image; or
a video.

5. The method of claim 1, wherein displaying an animated view of the 3D space comprises transitioning between sequential displays of document content via moving a virtual camera along the virtual path.

6. The method of claim 5, wherein transitioning between sequential displays of document content comprises displaying transitions between key frames of document content in the animated view of the 3D space.

7. The method of claim 1, wherein prior to anchoring document content to a plurality of objects within the 3D space:
displaying a plurality of 3D spaces from which a user is enabled to select; and
receiving a selection of a 3D space from the plurality of 3D spaces.

8. The method of claim 1, further comprising receiving a 3D space, wherein the 3D space is one of:
a collection of overlapping two-dimensional (2D) images that are reconstructed into a 3D model;
a recorded video capture; or
a computer-generated imagery (CGI) modeled environment.

9. A system for improving user efficiency in utilizing a productivity application for viewing a document with spatial context, the system comprising a computing device, the computing device comprising:
at least one processing device; and
at least one computer readable data storage device storing instructions that, when executed by the at least one processing device are operable to provide a productivity application, operative to:
receive an indication of a selection to reconfigure the document into a three-dimensional (3D) space;
anchor document content to a plurality of objects within the 3D space;
receive an indication of a selection to present the document; and
generate a display of an animated view of the 3D space including a sequential display of the document content anchored to the plurality of objects along a virtual path through the 3D space.

10. The system of claim 9, wherein the productivity application is further operative to:
display a plurality of 3D spaces from which a user is enabled to select; and
receive a selection of a 3D space from the plurality of 3D spaces.

11. The system of claim 9, wherein the 3D space is one of:
a collection of overlapping two-dimensional (2D) images that are reconstructed into a 3D model;
a recorded video capture; or
a computer-generated imagery (CGI) modeled environment.

12. The system of claim 9, wherein in anchoring document content to a plurality of objects within the 3D space, the productivity application is operative to anchor at least one of:
a document page;
textual content;
a chart;
a table;
an image; and
a video.

13. The system of claim 9, wherein:
the document is a slide presentation document; and
in anchoring document content to a plurality of objects within the 3D space, the productivity application is operative to anchor slides to a plurality of objects within the 3D space.

14. The system of claim 9, wherein in displaying an animated view of the 3D space, the productivity application is further operative to display transitions between sequential displays of document content, the transitions comprising movement of a virtual camera along the virtual path.

15. The system of claim 14, wherein the sequential displays of document content are key frames in the animated view of the 3D space.

16. A computer readable storage device including computer readable instructions, which when executed by a processing unit is operative to:
receive an indication of a selection to reconfigure the document into a three-dimensional (3D) space;
display a plurality of 3D spaces from which a user is enabled to select;
receive a selection of a 3D space from the plurality of 3D spaces;
anchor document content to a plurality of objects within the 3D space;
receive an indication of a selection to present the document; and
generate a display of an animated view of the 3D space including a sequential display of the document content anchored to the plurality of objects along a virtual path through the 3D space.

17. The computer readable storage device of claim 16, wherein:
the document is a slide presentation document; and
in anchoring document content to a plurality of objects within the 3D space, the productivity application is operative to anchor at least one of:
a slide;
textual content;
a chart;
a table;
an image; and
a video.

18. The computer readable storage device of claim 16, wherein displaying an animated view of the 3D space comprises displaying transitions between sequential displays of document content, the transitions comprising movement of a virtual camera along the virtual path.

19. The computer readable storage device of claim 16, wherein the sequential displays of document content are key frames in the animated view of the 3D space.

20. The computer readable storage device of claim 16, further comprising providing the 3D space, wherein the 3D space is one of:
a collection of overlapping two-dimensional (2D) images that are reconstructed into a 3D model;
a recorded video capture; or
a computer-generated imagery (CGI) modeled environment.
